(19) United States
(12) Patent Application Publication
(10) Pub. No.: US 2014/0025481 A1
(43) Pub. Date: Jan. 23, 2014

(54) BENEFIT PROMOTION ADVERTISING IN AN AUGMENTED REALITY ENVIRONMENT

(71) Applicants: Seok Tae KANG, Seoul (KR); Yu Kyoung KANG, Seoul (KR); Mhyoung Soo KANG, Seoul (KR)

(72) Inventors: Seok Tae KANG, Seoul (KR); Yu Kyoung KANG, Seoul (KR); Mhyoung Soo KANG, Seoul (KR)

(73) Assignee: LG CNS CO., LTD., Seoul (KR)

(21) Appl. No.: 13/553,885

(22) Filed: Jul. 20, 2012

(51) Int. Cl. G06Q 30/02

(52) U.S. Cl. CPC G06Q 30/0244
USPC 705/14.43

(57) ABSTRACT

Embodiments described herein provide approaches for benefit promotion advertising in an augmented reality (AR) environment. Specifically, users are presented with an advertisement overlay generated for a video sequence from a mobile device. The advertisement overlay comprises a set of AR objects, and an incentive to the user to interact with the AR objects of the advertisement overlay. Responses from the user are recognized, and a benefit is provided to the user based on the response to the incentive. As such, advertisement campaigns in the AR environment are made more appealing to the user and, consequently, more effective for the advertiser.

### BACKGROUND

1. Technical Field

This invention relates generally to augmented reality applications, and more specifically, to benefit promotion advertising using augmented reality.

2. Related Art

Augmented reality (AR) focuses on combining real world and computer-generated data, especially computer graphics objects blended into real footage in real time for display to an end-user. The scope of AR has expanded to include non-visual augmentation and broader application areas, such as advertising, navigation, and entertainment. There is increasing interest in providing seamless integration of such computer-generated data, including images and non-visual augmentation data, into real-world scenes.

The use of mobile devices, such as cellular phones or personal digital assistant (PDA) devices, has increased dramatically recent years. Often, such mobile devices include a camera and display for displaying images at which the camera is pointed. Since people usually carry their camera-capable mobile devices with them to a number of settings, a number of AR mobile applications for utilizing the camera and display capabilities of such mobile devices have emerged.

U.S. Pat. No. 8,180,396 describes a camera-enabled mobile device, which obtains metadata images/video metadata that is captured with the mobile device. As the user points the mobile device's camera at one or more objects in one or more scenes, such objects are automatically analyzed to identify the one or more objects and associated metadata. The metadata is interactive and allows the user to obtain additional information or specific types of information, such as information that will aid the user in making a decision regarding the identified objects or selectable action options that can be used to initiate actions with respect to the identified objects.

U.S. Patent Application No. 2012/0143361 describes an augmented reality system configured to provide an augmented reality image by integrating a real-world image and a virtual object, and to receive a message related to the virtual object and to translate spatial attributes of the virtual object into audio attributes of a sound file.

U.S. Patent Application No. 2012/0113142 describes combining computer-generated imagery with real-world imagery in a portable electronic device by retrieving, manipulating, and sharing relevant stored videos, preferably in real time. A video is captured with a hand-held device and stored. Metadata including the camera's physical location and orientation is appended to a data stream, along with user input. The server analyzes the data stream and further annotates the metadata, producing a searchable library of videos and metadata. Later, when a camera user generates a new data stream, the linked server analyzes it, identifies relevant material from the library, retrieves the material and tagged information, adjusts it for proper orientation, then renders and superimposes it onto the current camera view so the user views an augmented reality.

Therefore, what is needed is a meeting management approach for a mobile device that addresses at least one of the deficiencies of the current art.

### SUMMARY

In general, embodiments described herein provide approaches for benefit promotion advertising in an augmented reality environment. Specifically, users are presented with an advertisement overlay generated for a video sequence from a mobile device. The advertisement overlay comprises a set of AR objects, and an incentive to the user to interact with the AR objects of the advertisement overlay. Responses from the user are recognized, and a benefit (e.g., gift, coupon, etc.) is provided to the user based on the response to the incentive. As such, advertisement campaigns in the AR environment are made more appealing to the user and, consequently, more effective for the advertiser.

One aspect of the present invention includes a method for benefit promotion advertising in an augmented reality environment, comprising the computer-implemented steps of: receiving video data from a camera of a mobile device; generating a graphical overlay on the video data, the graphical overlay comprising a set of advertising objects; providing an incentive to a user of the mobile device to interact with the set of advertising objects; determining a response by the user to the incentive; and generating a benefit based on the response by the user to the incentive.

Another aspect of the present invention provides a system for benefit promotion advertising in an augmented reality environment, the system comprising: a memory medium comprising instructions; a bus coupled to the memory medium; and a processor coupled to an AR advertising system via the bus that when executing the instructions causes the system to: receive video data from a camera of a mobile device; generate a graphical overlay on the video data, the graphical overlay comprising a set of advertising objects; provide an incentive to a user of the mobile device to interact with the set of advertising objects; determine a response by the user to the incentive; and generate a benefit based on the response by the user to the incentive.

Another aspect of the present invention provides a computer-readable storage medium storing computer instructions, which when executed, enables a computer system to provide benefit promotion advertising in an augmented reality environment, the computer instructions comprising: receiving video data from a camera of a mobile device; generating a graphical overlay on the video data, the graphical overlay comprising a set of advertising objects; providing an incentive to a user of the mobile device to interact with the set of advertising objects; determining a response by the user to the incentive; and generating a benefit based on the response by the user to the incentive.

Another aspect of the present invention provides a method for benefit promotion advertising in an augmented reality environment, the method comprising: receiving, using a computer system, video data from a camera of a mobile device; generating, using the computer system, a graphical overlay on the video data, the graphical overlay comprising a set of advertising objects; providing, using the computer system, an incentive to a user of the mobile device to interact with the set of advertising objects; determining, using the computer system, a response by the user to the incentive; and generating, using the computer system, a benefit based on the response by the user to the incentive.

### BRIEF DESCRIPTION OF THE DRAWINGS

These and other features of this invention will be more readily understood from the following detailed description of the various aspects of the invention taken in conjunction with the accompanying drawings in which:

FIG. 1 shows a representation of network diagram according to illustrative embodiments.

FIG. 2 shows a representation of an exemplary computer implementation according to illustrative embodiments.

FIG. 3 shows a representation of an augmented reality (AR) advertising system according to illustrative embodiments.

FIG. 4 shows an operational flow chart of the mobile device and servers according to illustrative embodiments.

FIG. 5 shows a representation of advertising campaign information according to illustrative embodiments.

FIG. 6 shows an exemplary screen capture of an AR overlay according to illustrative embodiments.

FIG. 7 shows an illustrative process flow for determining entitlement to a benefit according to illustrative embodiments.

FIG. 8 shows an exemplary screen capture of a benefit according to illustrative embodiments.

The drawings are not necessarily to scale. The drawings are merely representations, not intended to portray specific parameters of the invention. The drawings are intended to depict only typical embodiments of the invention, and therefore should not be considered as limiting in scope. In the drawings, like numbering represents like elements.

### DETAILED DESCRIPTION

Exemplary embodiments now will be described more fully herein with reference to the accompanying drawings, in which exemplary embodiments are shown. Embodiments described herein provide approaches for benefit promotion advertising in an augmented reality (AR) environment. Specifically, users are presented with an advertisement overlay generated for a video sequence from a mobile device. The advertisement overlay comprises a set of AR objects, and an incentive to the user to interact with the AR objects of the advertisement overlay. Responses from the user are recognized, and a benefit (e.g., gift, coupon, money etc.) is provided to the user based on the response to the incentive. As such, advertisement campaigns in the AR environment are made more appealing to the user and, consequently, more effective for the advertiser.

It will be appreciated that this disclosure may be embodied in many different forms and should not be construed as limited to the exemplary embodiments set forth herein. Rather, these exemplary embodiments are provided so that this disclosure will be thorough and complete and will fully convey the scope of this disclosure to those skilled in the art. The terminology used herein is for the purpose of describing particular embodiments only and is not intended to be limiting of this disclosure. For example, as used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

Reference throughout this specification to “one embodiment,” “an embodiment,” “embodiments,” or similar language means that a particular feature, structure, or characteristic described in connection with the embodiment is included in at least one embodiment of the present invention. Thus, appearances of the phrases “in one embodiment,” “in an embodiment,” “in embodiments” and similar language throughout this specification may, but do not necessarily, all refer to the same embodiment.

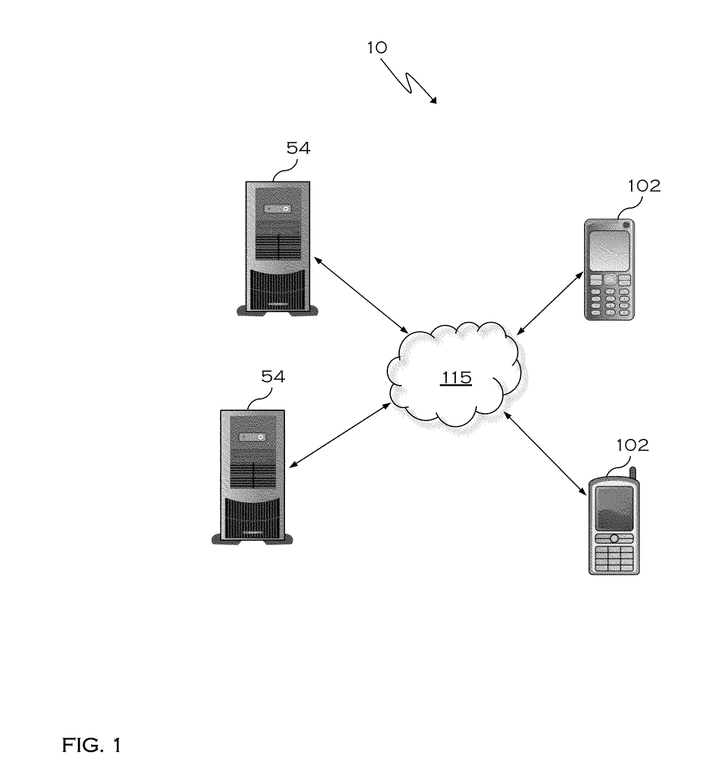

With reference now to the figures, FIG. 1 depicts a pictorial representation of a network data processing system 10 in which aspects of the illustrative embodiments may be implemented. Network data processing system 10 is a network of computers (e.g., mobile devices) in which embodiments may be implemented. Network data processing system 10 contains network 115, which is the medium used to provide communications links between various mobile devices, servers, and computers connected together within network data processing system 10. Network 115 may include connections, such as wire, wireless communication links, or fiber optic cables.

In the depicted example, servers 54 and a set of mobile devices 102 connect to network 115. These mobile devices may be, for example, personal computers (e.g., laptop computers and tablet computers), mobile telephones, personal digital assistants (PDAs), and the like. In the depicted example, servers 54 provide data, such as boot files, operating system images, and applications to mobile devices 102. Mobile devices 102 are clients to servers 54 in this example. Network data processing system 10 may include additional servers, clients, and other devices not shown. In exemplary embodiments described herein, servers 54 comprise one or more advertising campaign servers for providing the advertising content to the AR environment, as will be further described below.

In exemplary embodiments, network data processing system 10 is the Internet with network 115 representing a worldwide collection of networks and gateways that use the Transmission Control Protocol/Internet Protocol (TCP/IP) suite of protocols to communicate with one another. At the heart of the Internet is a system of high-speed data communication lines between major nodes or host computers, consisting of thousands of commercial, governmental, educational and other computer systems that route data and messages. Of course, network data processing system 10 also may be implemented as a number of different types of networks, such as for example, an intranet, a local area network (LAN), or a wide area network (WAN). Network data processing system 10 represents one environment in which one or more web-based applications operate with mobile devices 102, as will be described in further detail below. In one embodiment, network data processing system 10 represents an augmented reality environment. It will be appreciated that FIG. 1 is intended as an example, and not as an architectural limitation for different embodiments.

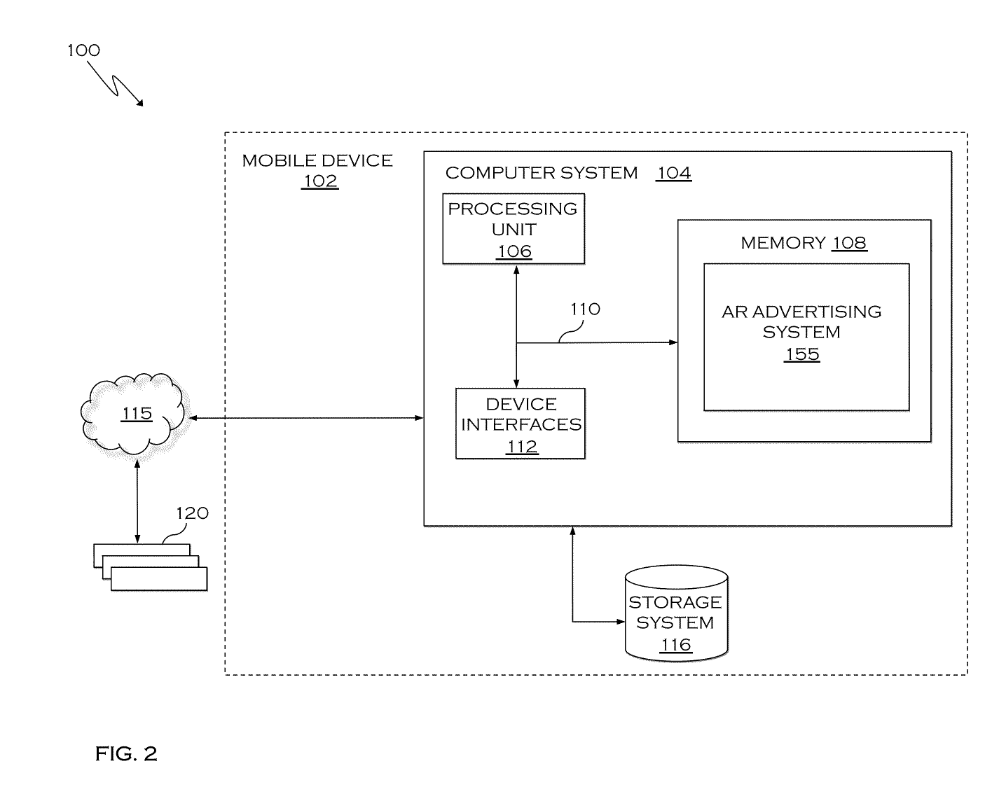

Turning now to FIG. 2, a computerized implementation 100 of the present invention will be described in greater detail. As depicted, implementation 100 includes computer system 104 deployed within a mobile device 102 (e.g., computer infrastructure). This is intended to demonstrate, among other things, that the present invention could be implemented within network environment 115 (e.g., the Internet, a wide area network (WAN), a local area network (LAN), a virtual private network (VPN), etc.), or on a stand-alone computer system. Still yet, the computer infrastructure of mobile device 102 is intended to demonstrate that some or all of the components of implementation 100 could be deployed, managed, serviced, etc., by a service provider who offers to implement, deploy, and/or perform the functions of the present invention for others.

Computer system 104 is intended to represent any type of computer system that may be implemented in deploying/realizing the teachings recited herein. In this particular example, computer system 104 represents an illustrative system for providing benefit promotion advertising in an AR environment. It should be understood that any other computers implemented under the present invention may have different components/software, but will perform similar functions. As shown, computer system 104 includes a processing unit 106 capable of operating with an AR advertising system 155 stored in a memory unit 108 to provide benefit promotion advertisements in the AR environment, as will be described in further detail below. Also shown is a bus 110, and device interfaces 112.

Processing unit 106 refers, generally, to any apparatus that performs logic operations, computational tasks, control functions, etc. A processor may include one or more subsystems, components, and/or other processors. A processor will typically include various logic components that operate using a clock signal to latch data, advance logic states, synchronize computations and logic operations, and/or provide other timing functions. During operation, processing unit 106 collects and routes data from a set of applications 120 (e.g., AR advertising campaigns, a graphical overlay application) from servers 54 to AR advertising system 155, as well as from device components (not shown). The signals can be transmitted over a LAN and/or a WAN (e.g., T1, T3, 56 kb, X.25), broadband connections (ISDN, Frame Relay, ATM), wireless links (802.11, Bluetooth, etc.), and so on. In some embodiments, the signals may be encrypted using, for example, trusted key-pair encryption. Different systems may transmit information using different communication pathways, such as Ethernet or wireless networks, direct serial or parallel connections, USB, Firewire®, Bluetooth®, or other proprietary interfaces. (Firewire is a registered trademark of Apple Computer, Inc. Bluetooth is a registered trademark of Bluetooth Special Interest Group (SIG)).

In general, processing unit 106 executes computer program code, such as program code for operating AR advertising system 155, which is stored in memory 108 and/or storage system 116. While executing computer program code, processing unit 106 can read and/or write data to/from memory 108 and storage system 116. Storage system 116 can include VCRs, DVRs, RAID arrays, USB hard drives, optical disk recorders, flash storage devices, and/or any other data processing and storage elements for storing and/or processing data. Although not shown, computer system 104 could also include I/O interfaces that communicate with one or more hardware device components of mobile device 102 that enable a user to interact with computer system 104 (e.g., a keyboard, a display, camera, etc.).

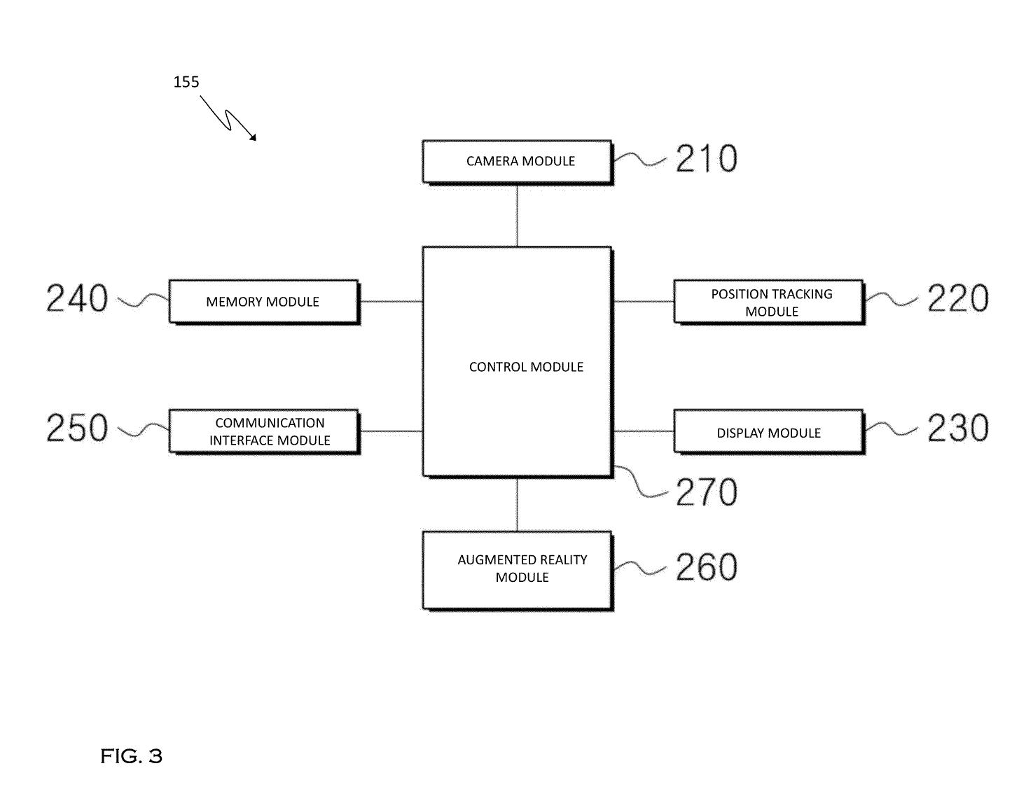

Referring to FIG. 3, the structure and operation of AR advertising system 155 of mobile device 102 according to embodiments of the invention will be described in greater detail. As shown, AR advertising system 155 of mobile device 102 comprises a camera module 210 configured to receive video image data from a camera (not shown) of mobile device 102. In one embodiment, as the user points the camera of mobile device 102 at one or more objects in one or more scenes, such objects are automatically analyzed by the camera module to identify the one or more objects and to provide metadata regarding the identified objects in the display of mobile device 102. The metadata is interactive and allows the user to obtain additional information or specific types of information. In one embodiment a user can continuously pass the camera over additional objects and scenes so that the metadata presented in the display of the mobile device is continuously updated.

AR advertising system 155 further comprises a position tracking module 220 configured to track the movement of mobile device 102, a display module 230 configured to control display of and interaction with the video image data from the camera along with a graphical overlay over the video image data, a memory module 240 operable with memory 116 (FIG. 2) and configured to store a set of advertising campaigns (e.g., application 120) from servers 54 (FIG. 1), a communication interface module 250 configured to provide connection and communication with servers 54, and an augmented reality module 260 configured to provide AR services, including generation of an AR overlay and virtual objects associated therewith. AR advertising system 155 further comprises a control module 270 configured to control each of the modules contained therein.

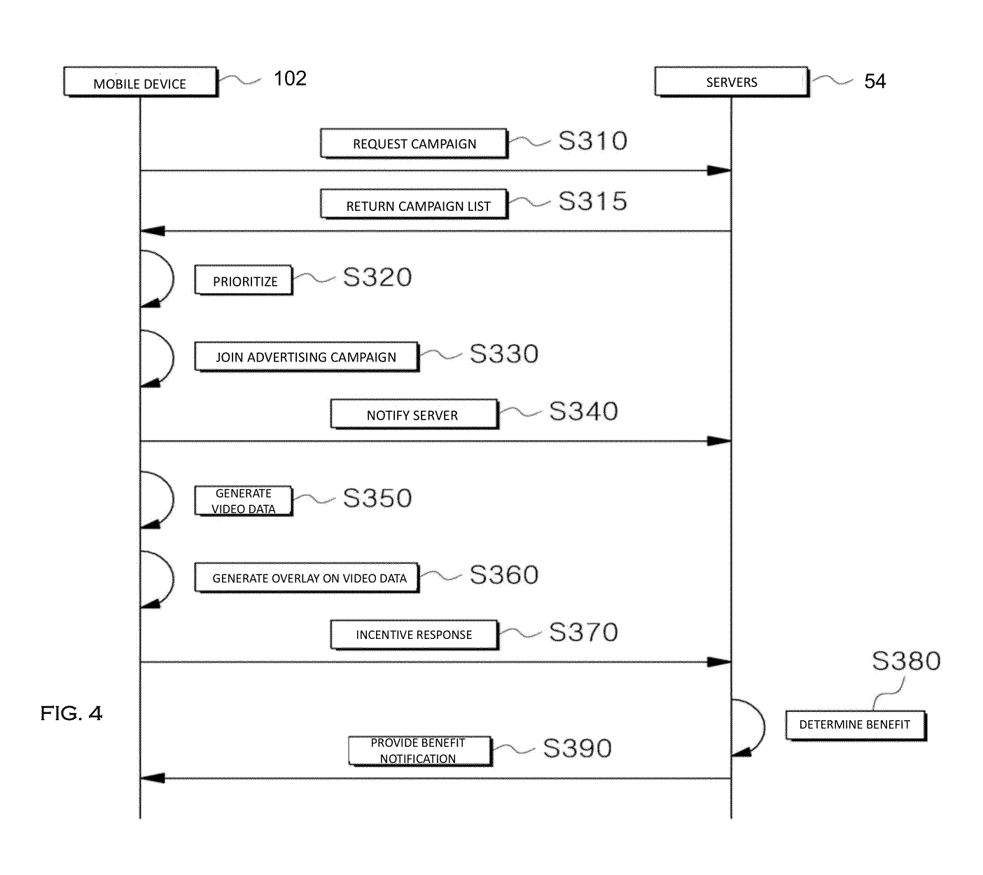

Referring now to FIG. 4, an interaction between mobile device 102 and servers 54 will be described in greater detail. At step (S) 310, mobile device 102 requests an advertising campaign (e.g., app 120), and a list of campaigns is returned to mobile device 102 from servers 54 at S315. Mobile device 102 may choose the advertising campaign from a list of campaigns, wherein the list is generated and prioritized (S320) based on the location of mobile device 102. The advertising campaigns on the list may cater to the location of mobile device 102. For example, it may be determined that a local advertising campaign (e.g., New York City area) can be preferably generated instead of a national advertising campaign (e.g., everywhere in the United States). However, it will also be appreciated that the location of the mobile device 102 can be disregarded for the sake of generating advertising campaigns, and that only national/state campaigns can be added to the list. In another embodiment, the list may be prioritized based on a fee paid by each advertiser on the list. The list can then be presented to the user based on the priority.

Next, at S330, mobile device 102 joins one of the advertising campaigns from the list, and notifies servers 54 at S340. Mobile device 102 activates camera module 210 and starts generating video data at S350. Next, at S360, a graphical overlay is generated on the video data, the graphical overlay comprising a set of advertising objects. An incentive to interact (e.g., an enticing and/or reward producing AR game) with the set of advertising object is generated and provided to the user, and a response to the incentive is determined at S370. At S380, it is determined whether the user had a successful interaction with a benefit-triggering area of the overlay of the graphical overlay, and if so, what type of benefit to provide to the user. At S390, mobile device 102 is notified of the benefit.

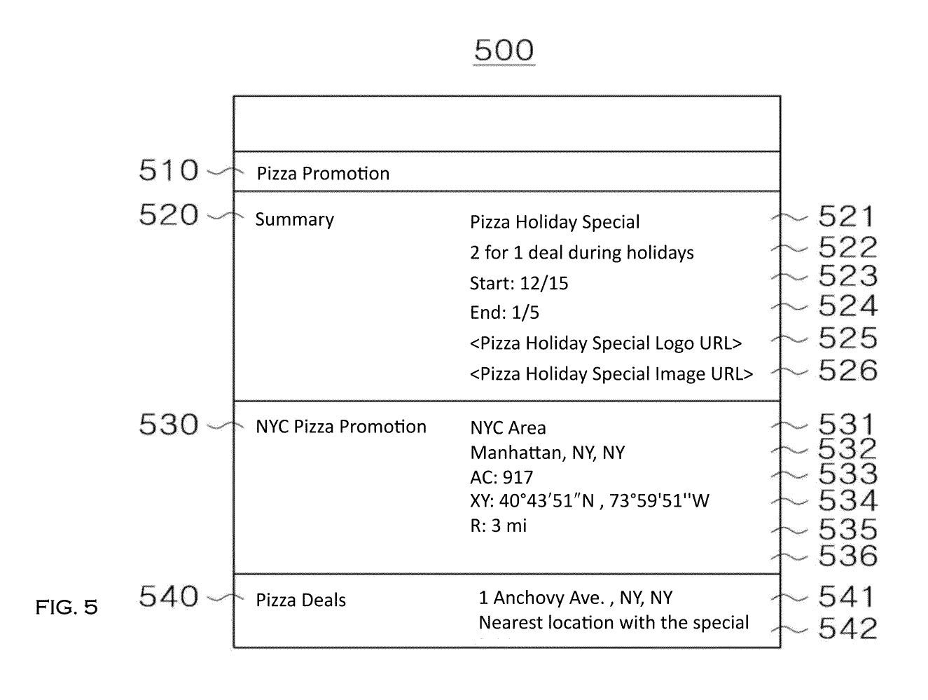

Referring now to FIG. 5, exemplary advertising campaign information 500 will be described in greater detail. In exemplary embodiments, campaign info 500 may be located in servers 54, and is accessed when mobile device 102 selects the campaign. Campaign information 500 can be presented as a bar code or expressed with XML or HTML text code, etc. As shown, campaign info 500 comprises a campaign idea 510, campaign bibliographic information 520, local campaign information 530, and the gift exchange location 540. In one embodiment, campaign idea 510 is used to categorize and distinguish between various campaigns on the campaign list.

Campaign bibliographic information 520 is related to the campaign and may contain a campaign name 521, campaign explanation 522, campaign start date 523, campaign end date 524, campaign logo image URL 525 and campaign image URL 526. Campaign name 521 and explanation 522 are the mobile device user campaign information. It displays whenever the user requests information before step S310 (FIG. 4).

Campaign geographical information 530 is the local campaign area information. In one embodiment, it contains the local name 531, detailed local geographical name 532, local area code 533, geographical position 534, and radius 535. Local area code 533 and detailed geographical position 534 are used to distinguish the areas that are affected by the campaign.

The gift exchange location 540 is the location 541 and location explanation 542. Location 540 can be presented in any number of non-limiting ways, including via a mobile device GPS/map location. When multiple gift exchange locations are available, the location of the nearest one can be provided to mobile device 102.

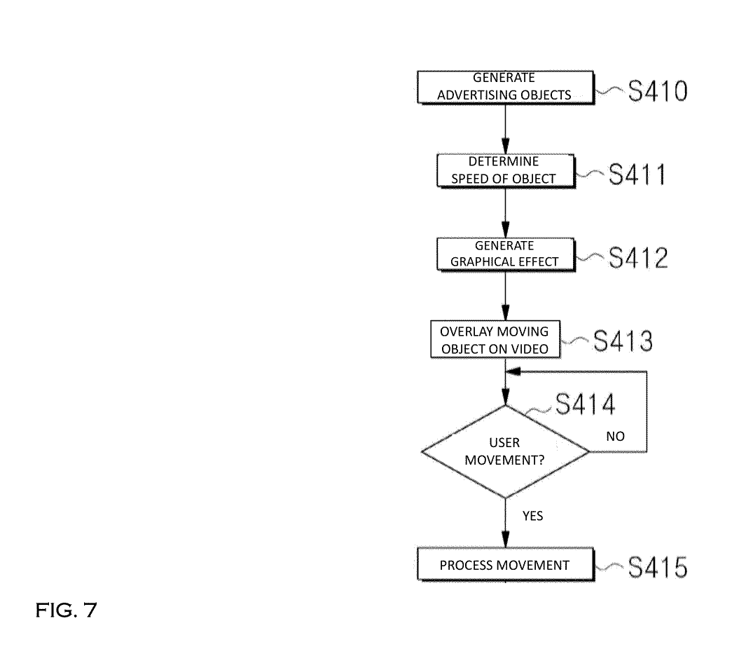

Referring now to the depiction of an exemplary AR overlay 1000 shown in FIG. 7, a non-limiting approach for providing AR benefit promotion advertising will be described in greater detail. As shown, overlay 1000 comprises floating objects 1040 and 1050, a moving object 1020, and a benefit-triggering area 1035 of overlay 1000, all of which are superimposed over video 1010 received from the camera of mobile device 102. In this embodiment, the incentive/enticement for the user to interact with the AR advertising objects is a game of catch using baseballs (1020). In this AR game, the user attempts to “catch” the moving baseballs, a moving object 1020, using a baseball glove, the center of which generally corresponds to benefit-triggering area 1035. During operation, one or more baseball moving objects 1020 are released from a hot-air balloon floating object 1040. Mobile device 102 is manipulated by the user in an attempt to catch the baseball (i.e., line-up or bring together moving object 1020 and benefit-triggering area 1035 of overlay 1000). If the user is successful, one or more benefits are triggered, as will be further described below. However, if the user is unsuccessful and the baseball misses the glove, i.e., the moving object 1020 enters a section of final area 1030 falling outside of benefit-triggering area 1035, the benefit is not triggered, and the user must try again, for example.

In this embodiment, floating ad item 1040 appears to create moving items 1020 (i.e., baseballs), which can be an effective way to promote the advertising campaign. Furthermore floating ad item 1040 is defined to float on video 1010 that is being captured by the camera module 210. In one embodiment, the floating advertising item 1040 may work only on a predefined display area. In one embodiment, floating advertising item 1040 can move according to:

\vec{v_{f}(t)}=f_{a((x1,y1),(x2,y2))}(\vec{v_{f}(t−1)})

wherein \vec{v_{f}(t)} is the speed constant in time t, and f_{a((x1,y1),(x2,y2))}(\vec{v_{f}(t−1)}) is the speed value of the t−1 time slot in special area.

Floating advertising items 1040 are configured to receive an action from the user (e.g., a touch, click, etc.). Upon interaction, augmented reality creation module 260 may generate a pop-for the specific information display. In one embodiment, augmented reality creation module 260 generates a pop-up to show a list of gift exchange locations and/or directions to the nearest one.

In one embodiment, floating advertising items 1050 can be generated by an object or a pre-defined shape comparison, e.g., through character recognition. For example, image recognition of a particular sign or company logo within video 1010 can trigger the generation of advertising items floating object 1050. The speed of floating object advertising items 1050 may be calculated using the same method as for floating advertising items 1040. Furthermore, floating advertising items 1050 can similarly responds to a user action (e.g., touch).

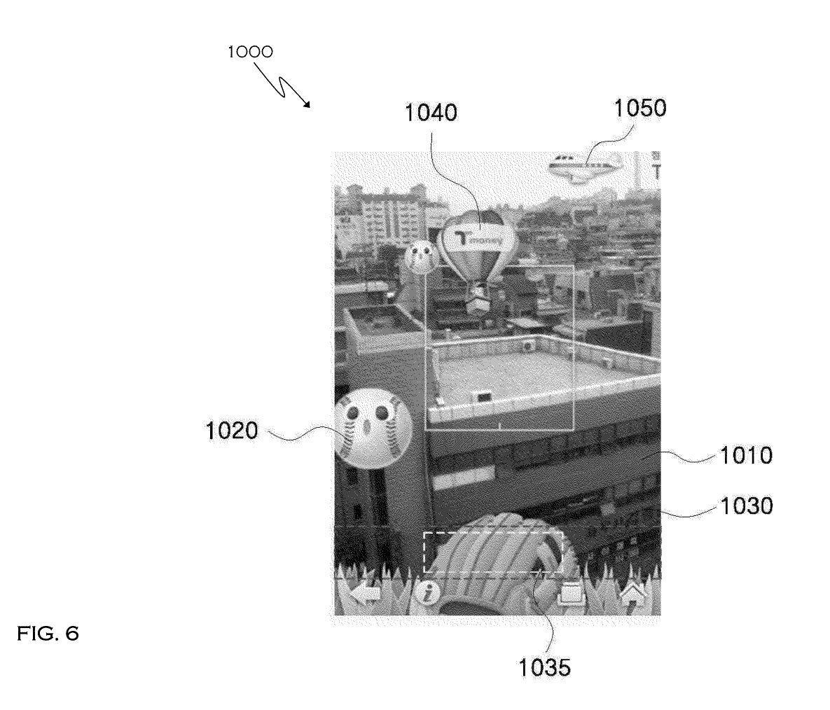

Referring now FIG. 6-7, non-limiting flow chart for providing AR benefit promotion advertising will be described in greater detail. As shown, the approach begins and at S410, wherein a set of AR advertising objects is generated, including floating objects 1040 and 1050, moving object 1020, and benefit-triggering area 1035. At 411, a speed of moving object 1020 is determined, wherein the speed constant value can be expressed with the following mathematical equation, wherein consideration is given for a weight of moving object 1020:

\vec{v_{ε(φ)}(t)}\vec{v_{ε(φ)}(t)}=\vec{v_{ε(φ)}}+\vec{f_{ε(φ)}(x,y)}\vec{f_{ε(φ)}(x,y)}

wherein \vec{v_{ε(φ)}(t)}\vec{v_{ε(φ)}(t)} is a speed constant,

\vec{v_{ε(φ)}} is the start speed value,

\vec{f_{ε(φ)}(x,y)}\vec{f_{ε(φ)}(x,y)} is the value of the image position on the captured video,

|\vec{v_{ε(φ)}}|≦|\vec{f_{ε(φ)}(x,y)}\vec{f_{ε(φ)}(x,y)}|+|c| where c is an absolute constant value, and

\vec{f_{ε(φ)}(x,y)}\vec{f_{ε(φ)}(x,y)} is the weight of the moving item 1020.

Next, at S412, any graphical effects for moving object 1020 are provided. For example, moving object 1020 may be represented as a baseball, as shown in FIG. 6.

At S413, moving object 1020 is overlaid on video 1010, and movement of the user is determined at S414. If movement is sensed, it is then processed at S415 to determine its impact. In exemplary embodiments, processing the movement comprises at least one of the following: (i) determining movement of the mobile device based on a change in the video data, (ii) determining a movement of the mobile device based on a change in the video data relative to the moving object, and (iii) determining the user's interaction with the moving object and the benefit-triggering area 1035 of overlay 1000.

Here item (i) and item (ii) can work conversely and the user can choose one approach. In case of item (ii), when mobile device 102 moves left, for example, video display 1010 can move left while moving item 1020 moves at the original speed. In case of item (i), when mobile device 102 moves left, video display 1010 and moving item 1020 can move left together. In case of item (iii), mobile device 102 moves back and forward within a predetermined time interval as the user attempts to “catch” moving object 1020. AR generation module 260 (FIG. 3) determines the relative positions of catch area (i.e., benefit-triggering area) 1035, final area 1035, and moving item 1020 as the user moves mobile device 102 to determine if moving item 1020 and catch area 1035 meet.

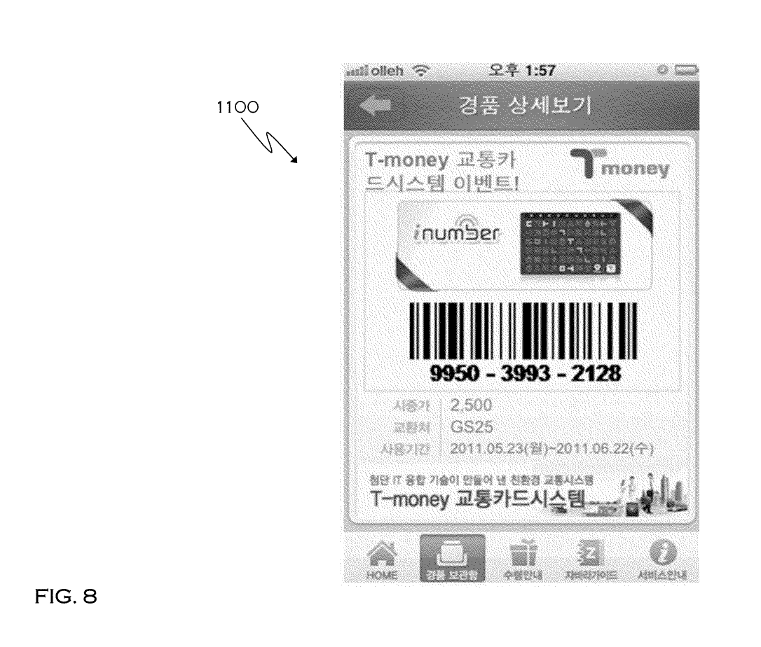

Referring now to FIG. 8, an exemplary representation of a benefit 1100 provided to the user will be described in greater detail. In this non-limiting example, it has been determined that the user is entitled to a monetary benefit, which is shown as mobile device-based “T-Money.” T-money can be used in lieu of cash or credit cards in those stores and business that are equipped and willing to accept it. Benefit 1100 can be earned/granted via any number of implementations. For example, benefit 1100 may be earned based on a predetermined number of successful “catches” by the user. Additionally, a weighting factor can be used for the success computation (i.e., not all catches are valued the same). This weighting may be visually presented as part of the overlay. In another embodiment, the deposited benefit 1100 can be transferred to other devices owned by the same user, or transferred to another user with permission.

It can be appreciated that the approaches disclosed herein can be used within a computer system to provide benefit promotion advertising in an AR environment. To this extent, the deployment can comprise one or more of (1) installing program code on a computing device, such as a computer system, from a computer-readable storage medium; (2) adding one or more computing devices to the infrastructure; and (3) incorporating and/or modifying one or more existing systems of the infrastructure to enable the infrastructure to perform the process actions of the invention.

The exemplary embodiments may be described in the general context of computer-executable instructions, such as program modules, being executed by a computer. Generally, program modules include routines, programs, people, components, logic, data structures, and so on, which perform particular tasks or implement particular abstract data types. An exemplary computer system may be practiced in distributed computing environments where tasks are performed by remote processing devices that are linked through a communications network. In a distributed computing environment, program modules may be located in both local and remote computer storage media including memory storage devices.

The flowcharts of FIGS. 4 and 7 illustrate the architecture, functionality, and operation of possible implementations of systems, methods, and computer program products according to various embodiments of the present invention. In this regard, each block in the flowchart may represent a module, segment, or portion of code, which comprises one or more executable instructions for implementing the specified logical function(s). It should also be noted that, in some alternative implementations, the functions noted in the blocks might occur out of the order depicted in the figures. For example, two blocks shown in succession may, in fact, be executed substantially concurrently. It will also be noted that each block of flowchart illustration can be implemented by special purpose hardware-based systems that perform the specified functions or acts, or combinations of special purpose hardware and computer instructions.

Some of the functional components described in this specification have been labeled as systems or units in order to more particularly emphasize their implementation independence. For example, a system or unit may be implemented as a hardware circuit comprising custom VLSI circuits or gate arrays, off-the-shelf semiconductors such as logic chips, transistors, or other discrete components. A system or unit may also be implemented in programmable hardware devices such as field programmable gate arrays, programmable array logic, programmable logic devices or the like. A system or unit may also be implemented in software for execution by various types of processors. A system or unit or component of executable code may, for instance, comprise one or more physical or logical blocks of computer instructions, which may, for instance, be organized as an object, procedure, or function. Nevertheless, the executables of an identified system or unit need not be physically located together, but may comprise disparate instructions stored in different locations which, when joined logically together, comprise the system or unit and achieve the stated purpose for the system or unit.

Further, a system or unit of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices and disparate memory devices.

Furthermore, as will be described herein, systems/components may also be implemented as a combination of software and one or more hardware devices. For example, AR advertising system 155 may be embodied in the combination of a software executable code stored on a memory medium (e.g., memory storage device). In a further example, a system or component may be the combination of a processor that operates on a set of operational data.

As noted above, some of the embodiments may be embodied in hardware. The hardware may be referenced as a hardware element. In general, a hardware element may refer to any hardware structures arranged to perform certain operations. In one embodiment, for example, the hardware elements may include any analog or digital electrical or electronic elements fabricated on a substrate. The fabrication may be performed using silicon-based integrated circuit (IC) techniques, such as complementary metal oxide semiconductor (CMOS), bipolar, and bipolar CMOS (BiCMOS) techniques, for example. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor devices, chips, microchips, chip sets, and so forth. However, the embodiments are not limited in this context.

Also noted above, some embodiments may be embodied in software. The software may be referenced as a software element. In general, a software element may refer to any software structures arranged to perform certain operations. In one embodiment, for example, the software elements may include program instructions and/or data adapted for execution by a hardware element, such as a processor. Program instructions may include an organized list of commands comprising words, values, or symbols arranged in a predetermined syntax that, when executed, may cause a processor to perform a corresponding set of operations.

In one embodiment, an implementation of exemplary computer system 104 may be stored on or transmitted across some form of computer-readable storage medium. Computer-readable storage medium can be media that can be accessed by a computer. “Computer-readable storage medium” includes volatile and non-volatile, removable and non-removable computer storable media implemented in any method or technology for storage of information such as computer readable instructions, data structures, program modules, or other data. Computer storage device includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer. “Communication medium” typically embodies computer readable instructions, data structures, and program modules. Communication media also includes any information delivery media.

It is apparent that there has been provided an approach for structured communication for benefit promotion advertising in an augmented reality environment. While the invention has been particularly shown and described in conjunction with exemplary embodiments, it will be appreciated that variations and modifications will occur to those skilled in the art. Therefore, it is to be understood that the appended claims are intended to cover all such modifications and changes that fall within the true spirit of the invention.

What is claimed is:

1. A method for benefit promotion advertising in an augmented reality environment, the method comprising the computer-implemented steps of:
receiving video data from a camera of a mobile device;
generating a graphical overlay on the video data, the graphical overlay comprising a set of advertising objects;
providing an incentive to a user of the mobile device to interact with the set of advertising objects;
determining a response by the user to the incentive; and
generating a benefit based on the response by the user to the incentive.

2. The method according to claim 1, further comprising the computer-implemented steps of:
determining a location of the mobile device; and
generating the graphical overlay on the video data based on the location of the mobile device.

3. The method according to claim 1, the set of advertising objects comprising at least one of: a floating object, a moving object, and a benefit-triggering area of the overlay.

4. The method according to claim 3, the computer implemented step of determining a response by the user comprising at least one of the following: determining movement of the mobile device based on a change in the video data, determining a movement of the mobile device based on a change in the video data relative to the moving object, and determining the user's interaction with the moving object and the benefit-triggering area of the overlay.

5. The method according to claim 4, further comprising the computer-implemented step of providing the benefit to the user in response to a successful interaction with the benefit-triggering area of the overlay, wherein a notification of the benefit is received on the mobile device.

6. A system for benefit promotion advertising in an augmented reality environment, the system comprising:
a memory medium comprising instructions;
a bus coupled to the memory medium; and
a processor coupled to an augmented reality advertising system via the bus that when executing instructions causes the system to:
receive video data from a camera of a mobile device;
generate a graphical overlay on the video data, the graphical overlay comprising a set of advertising objects;
provide an incentive to a user of the mobile device to interact with the set of advertising objects;
determine a response by the user to the incentive; and
generate a benefit based on the response by the user to the incentive.

7. The system according to claim 6, further comprising instructions causing the system to:
determine a location of the mobile device; and
generate the graphical overlay on the video data based on the location of the mobile device.

8. The system according to claim 6, the set of advertising objects comprising at least one of: a floating object, a moving object, and a benefit-triggering area of the overlay.

9. The system according to claim 8, the instructions causing the system to determine the response from the user comprising at least one of the following: determine movement of the mobile device based on a change in the video data, determine a movement of the mobile device based on a change in the video data relative to the moving object, and determine the user's interaction with the moving object and the benefit-triggering area of the overlay.

10. The system according to claim 9, further comprising computer instructions causing the system to provide the benefit to the user in response to a successful interaction with the benefit-triggering area of the overlay, wherein a notification of the benefit is received on the mobile device.

11. A computer-readable storage medium storing computer instructions, which when executed, enables a computer system to provide benefit promotion advertising in an augmented reality environment, the computer instructions comprising:
receiving video data from a camera of a mobile device;
generating a graphical overlay on the video data, the graphical overlay comprising a set of advertising objects;
providing an incentive to a user of the mobile device to interact with the set of advertising objects;
determining a response by the user to the incentive; and
generating a benefit based on the response by the user to the incentive.

12. The computer-readable storage medium according to claim 11 further comprising computer instructions comprising:
determining a location of the mobile device; and
generating the graphical overlay on the video data based on the location of the mobile device.

13. The computer-readable storage medium according to claim 11, the set of advertising objects comprising at least one of: a floating object, a moving object, and a benefit-triggering area of the overlay.

14. The computer-readable storage medium according to claim 13, the computer instructions for determining the response by the user comprising at least one of the following: determining movement of the mobile device based on a change in the video data, determining a movement of the mobile device based on a change in the video data relative to the moving object, and determining the user's interaction with the moving object and the benefit-triggering area of the overlay.

15. The computer-readable storage medium according to claim 14, further comprising computer instructions for providing the benefit to the user in response to a successful interaction with the benefit-triggering area of the overlay, wherein a notification of the benefit is received on the mobile device.

16. A method for providing benefit promotion advertising in an augmented reality environment, the method comprising:
receiving, by a computer system, video data from a camera of a mobile device;
generating, by the computer system, a graphical overlay on the video data, the graphical overlay comprising a set of advertising objects;
providing, by the computer system, an incentive to a user of the mobile device to interact with the set of advertising objects;
determining, by the computer system, a response by the user to the incentive; and
generating, by the computer system, a benefit based on the response by the user to the incentive.

17. The method according to claim 16, further comprising:
determining, by the computer system, a location of the mobile device; and
generating, by the computer system, the graphical overlay on the video data based on the location of the mobile device.

18. The method according to claim 16, the set of advertising objects comprising at least one of: a floating object, a moving object, and a benefit-triggering area of the overlay.

19. The method according to claim 18, the determining the response by the user comprising at least one of the following: determining, by the computer system, movement of the mobile device based on a change in the video data, determining, by the computer system, a movement of the mobile device based on a change in the video data relative to the moving object, and determining, by the computer system, the user's interaction with the moving object and the benefit-triggering area of the overlay.

20. The method according to claim 19 further comprising providing, by the computer system, the benefit to the user in response to a successful interaction with the benefit-triggering area of the overlay, wherein a notification of the benefit is received on the mobile device.
